(19) United States
(12) Patent Application Publication
(10) Pub. No.: US 2026/0095767 A1
(43) Pub. Date: Apr. 2, 2026

(54) METHOD FOR CONNECTING A CONNECTED OBJECT TO A TELECOMMUNICATIONS NETWORK, AND ASSOCIATED DEVICE

(71) Applicant: IDEMIA FRANCE, Courbevoie (FR)

(72) Inventors: David GAUVIN, Courbevoie (FR); Jérôme DUMOULIN, Courbevoie (FR)

(73) Assignee: IDEMIA FRANCE, Courbevoie (FR)

(21) Appl. No.: 19/345,670

(22) Filed: Sep. 30, 2025

(30) Foreign Application Priority Data
Sep. 30, 2024 (FR) FR2410460

(51) Int. Cl. H04W 12/08; H04W 76/10

(52) U.S. Cl. CPC H04W 12/08; H04W 76/10

(57) ABSTRACT

A method for connecting a connected object embedding a secure element to a telecommunications network. The method includes the secure element receiving an access point name issued beforehand by a manager for managing secure elements of connected objects or by an operator profile manager, the secure element activating an operator profile associated with said operator, the operator profile being stored within the secure element and the connected object connecting to the telecommunications network of the operator using said access point name.

### TECHNICAL FIELD

The present invention belongs to the general field of telecommunications. It relates more particularly to a method for connecting a connected object to a telecommunications network. It also relates to a connected object configured to implement such a method. It relates, lastly, to a telecommunications system comprising a connected object, and a manager for managing secure elements of connected objects and/or an operator profile manager.

The invention lies more particularly in the context of a connected object embedding an eUICC (embedded universal integrated circuit card)-type secure element.

### PRIOR ART

As is known per se, eUICC-type secure elements are used to control access to a mobile telephony network, and are embedded in electronic devices. The term “embedded” is understood to mean that the secure element is not easily accessible or replaceable, or that it is not intended to be accessible or replaceable. A secure element embedded in an electronic device-and referred to hereinafter as an “eUICC”—may or may not be integral with this electronic device, and differs in particular from a conventional “SIM” card (which is for example “non-embedded”) in that it is configurable remotely (“over-the-air”).

The GSMA (acronym for “GSM Association”) acts as a standardization body and has defined multiple rules and guidelines concerning eUICC-type secure elements when these are embedded in connected objects. These connected objects (sometimes also called “intelligent objects”) are electronic devices characterized by their ability to interact with their immediate environment, generally through a microcontroller for controlling a sensor and/or an actuator, and also by their connectivity. These objects are connected to a communication network, such as for example the public Internet network within the framework of the Internet of Things (IoT), and are thereby able to communicate with other systems in order to obtain and/or provide information. Connected objects thus make it possible to capture and report back, to the network, the current value of information specific to their environment and/or to their operation, and/or to receive, from the network, a command the execution of which may have an effect on this environment and/or this operation.

In order to be able to be configured remotely without the involvement of a user, an eUICC comprises data needed to establish a wireless communication, which is for example initiated when the electronic device (for example the connected object) is first connected, or in the event of a malfunction. These data are sometimes called a “provisioning profile”. An eUICC also comprises data relating to a subscription taken out with a mobile telephony operator, also called an “operator profile”. An operator profile is specific to a mobile telephony operator insofar as it authorizes access only to a particular infrastructure. By way of example, the operator profile may include information about the hardware and/or software entities of the infrastructure to be contacted, and cryptographic data.

In order to be able to connect to a communication network, such as the Internet, a connected object must also have an access point name (APN). This name typically allows an electronic device to connect to the Internet by identifying an interconnection gateway located between the mobile network and an IP network. This gateway is sometimes called a gateway GPRS support node, GGSN in the context of 2G (second generation of mobile telephony technologies) or 3G (third generation), and a packet data network gateway, PGW, in the context of 4G (fourth generation) or 5G (fifth generation).

An access point name is also specific to an operator insofar as it authorizes access only to a particular infrastructure. Therefore, a change of operator profile typically results in a change of access point name. However, the memory resources of connected objects are relatively limited and do not allow a large number of access point names to be stored. Moreover, the standards defined up to now by the GSMA do not allow an access point name to be parametrized for a specific operator profile, in particular in the event of a change of operator profile.

There is therefore a need to improve existing solutions in terms of connecting a connected object to a telecommunications network.

### SUMMARY OF THE INVENTION

The present invention aims to rectify all or some of the drawbacks of the prior art, in particular those outlined above, by proposing a solution that makes it possible to parametrize an access point name for a connected object embedding a secure element.

To this end, and according to a first aspect, the invention relates to a method for connecting a connected object embedding a secure element to a telecommunications network, the method comprising:
the secure element receiving an access point name issued beforehand by a manager for managing secure elements of connected objects or by an operator profile manager, the access point name being associated with an operator of the telecommunications network;
the secure element activating an operator profile associated with said operator, the operator profile being stored within the secure element; and
the connected object connecting to the telecommunications network of the operator using said access point name.

The manager for managing secure elements of connected objects corresponds for example to the “eSIM IoT Remote Manager”, eIM, as defined in section 4.2.1 of the “SGP.31 eSIM IoT Architecture and Requirements” standard, version 1.0, published Apr. 19, 2022 by the GSMA, and called SGP.31 below.

The operator profile manager corresponds for example to the “Subscription Manager Data Preparation Plus”, SM-DP+, as defined in the “SGP.22 RSP Technical Specification” standard, version 3.0, published Oct. 19, 2022 by the GSMA, and called SGP.22 below.

In general, it will be considered that the steps of a method should not be interpreted as being related to a concept of temporal succession.

In some particular modes of implementation, the connection method may furthermore comprise one or more of the following features, taken on their own or in all technically feasible combinations.

In some particular modes of implementation, the method furthermore comprises, prior to activation,
the connected object receiving, from the secure element, said access point name and a command, referred to as “first command”, aimed at adding said name to a set of one or more access point names able to be used by the connected object; and
the connected object adding said access point name to said set of one or more access point names.

This first command corresponds for example to the “RUN AT COMMAND” command as defined in section 6.4.23 of the ETSI TS 102 223 standard, version V14.1.1, published by ETSI in July 2018.

In some particular modes of implementation, the connection method furthermore comprises the manager for managing secure elements of connected objects transmitting said access point name to the secure element via a connected object profile assistant.

In some particular modes of implementation, the connected object profile assistant is embedded within the secure element or the connected object.

In some particular modes of implementation, the connected object profile assistant conforms to the object profile assistant, IPA (“IoT Profile Assistant”), as defined in section 4 of the SGP.31 standard.

In some particular modes of implementation, the connected object profile assistant is embedded within the connected object, and the access point name is transmitted by the connected object profile assistant to the secure element using an “ES10b”-type interface.

This “ES10b” interface conforms for example to the SGP.31 standard.

In some particular modes of implementation, the access point name is transmitted by the manager for managing secure elements of connected objects to the secure element with a command, referred to as “second command”, able to be interpreted by said secure element and aimed at transmitting said “first command” to the connected object.

The access point name is thus for example transmitted as a parameter, a specific command (called “UpdateAPNList” in the remainder of the description).

In some particular modes of implementation, the access point name is transmitted by the manager for managing secure elements of connected objects to the secure element with a command, referred to as “third command”, to activate an operator profile of the secure element (eUICC), said third command comprising a parameter representative of a request to update the set of access point names of the connected object.

This third command corresponds for example to the “EnableProfile” command as defined in the SGP.22 standard.

The parameter corresponds for example to a Boolean indicator (called “UpdateList” in the remainder of the description).

In some particular modes of implementation, the access point name and, where applicable, the second command or the third command are transmitted in a data package.

This data package corresponds for example to the “eIMPackage” package as defined by the “SGP.32 eSIM IoT Technical Specification” standard, version 1.0.1, published by the GSMA on Jul. 4, 2023, and called SGP.32 hereinafter.

In some particular modes of implementation, the access point name is transmitted by the operator profile manager as part of loading an operator profile onto the secure element of the connected object, and the receiving furthermore comprises receiving said operator profile.

In some particular modes of implementation, the method furthermore comprises the secure element processing said access point name as a metadatum associated with said operator profile.

According to a second aspect, the invention relates to computer programs comprising instructions for implementing a connection method when said programs are executed by a computer.

These programs may use any programming language, and take the form of source code, object code, or intermediate code between source code and object code, such as in a partially compiled form, or in any other desirable form.

According to a third aspect, the invention relates to a computer-readable recording medium on which the computer programs according to the invention are recorded.

The information medium or recording medium may be any entity or device capable of storing the programs. For example, the medium may comprise a storage means, such as a ROM, for example a CD-ROM or a microelectronic circuit ROM, or else a magnetic recording means, for example a hard disk.

Moreover, the information medium or recording medium may be a transmissible medium such as an electrical or optical signal, which may be routed via an electrical or optical cable, by radio or by other means. The programs according to the invention may in particular be downloaded over an Internet network.

As an alternative, the information medium or recording medium may be an integrated circuit in which the programs are incorporated, the circuit being designed to execute or to be used in the execution of the method in question.

According to a fourth aspect, the invention relates to a connected object embedding a secure element and comprising:
a module for receiving, within the secure element, an access point name issued beforehand by a manager for managing secure elements of connected objects or by an operator profile manager, the access point name being associated with an operator of the telecommunications network;
a module for activating, within the secure element, an operator profile associated with said operator, the operator profile being stored within the secure element; and
a module for connecting to the telecommunications network of the operator using said access point name.

According to a fifth aspect, the invention relates to a telecommunications system comprising a manager for managing secure elements of connected objects and a connected object according to the invention.

According to a sixth aspect, the invention relates to a telecommunications system comprising an operator profile manager and a connected object according to the invention.

### BRIEF DESCRIPTION OF THE DRAWINGS

Other features and advantages of the present invention will become apparent from the description given below, with reference to the appended drawings, which illustrate one exemplary embodiment thereof that is completely non-limiting in nature. In the figures:

FIG. 1 is a schematic depiction of a telecommunications system, according to a first exemplary implementation;

FIG. 2 is a schematic depiction of a telecommunications system, according to a second exemplary implementation;

FIG. 3 shows modules embedded in a connected object, such as the connected object belonging to the telecommunications system from FIG. 1 or 2, according to one exemplary implementation of the invention;

FIG. 4 schematically shows one example of a hardware architecture of a connected object, such as the connected object belonging to the telecommunications system from FIG. 1 or 2;

FIG. 5 shows, in the form of a flowchart, a first particular mode of implementation of a connection method;

FIG. 6 shows, in the form of a flowchart, a second particular mode of implementation of a connection method; and

FIG. 7 shows, in the form of a flowchart, a third particular mode of implementation of a connection method.

### DESCRIPTION OF EMBODIMENTS

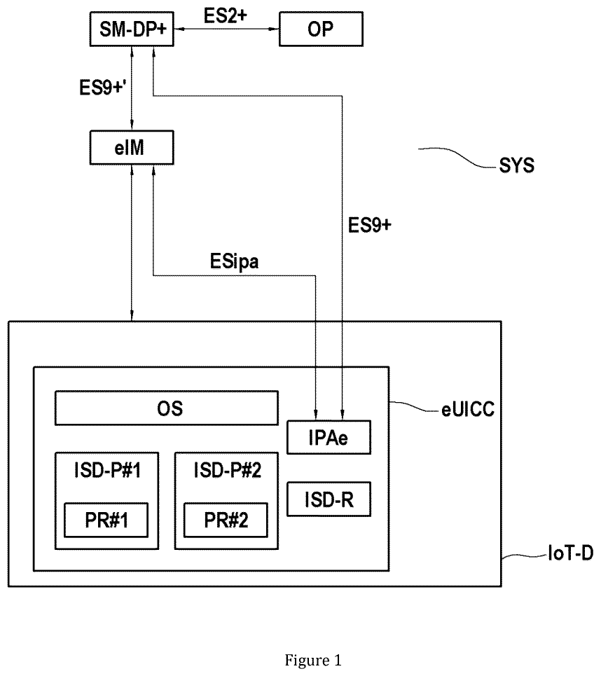

FIG. 1 is a schematic depiction of a telecommunications system, according to a first exemplary implementation.

As illustrated in FIG. 1, the telecommunications system SYS comprises a telecommunications operator OP connected to an operator profile manager SM-DP+. The operator OP is thereby able for example to transmit, to the manager SM-DP+, a request aimed at providing a specific operator profile to a given secure element. The operator OP and the operator profile manager SM-DP+ are for example connected via an ES2+ interface, as defined by the SGP.21, SGP.22 or SGP.31 standard.

The operator profile manager SM-DP+ conventionally takes the form of a server, and is responsible for preparing and storing operator profiles. It also performs a role of securing operator profiles and a role of respectively assigning an operator profile to the eUICC for which it is intended. Finally, the SM-DP+ also performs a role in the remote downloading of profiles and data associated with these profiles intended for the eUICCs for which it is responsible. The operator profile manager corresponds for example to the “Subscription Manager Data Preparation Plus”, SM-DP+, as defined in the SGP.22 or SGP.31 standard.

The telecommunications system furthermore comprises a manager eIM for managing secure elements of connected objects. This manager eIM is configured to remotely manage the downloading of profiles and data associated with these profiles or to implement profile administration functions, such as those defined for example in the SGP.31 standard. A manager eIM may be configured to manage a single connected object or a fleet of connected objects, and may be executed on a server or a user terminal, such as a laptop computer or a smartphone.

Since connected objects typically have limited power, memory and/or processing capacities, a manager eIM may also act as an intermediary between a connected object and a manager SM-DP+, firstly by communicating with this connected object using a lightweight communication protocol, and secondly by communicating with the manager SM-DP+ using a client/server communication protocol, such as the HTTP (acronym for “Hypertext Transfer Protocol”) or HTTPS (acronym for “HTTP secure”) protocol, between the manager SM-DP+ and this manager eIM. Using this manager eIM advantageously makes it possible to load and manage profiles of an eUICC, while at the same time ensuring end-to-end security between the eUICC and the manager SM-DP+. As mentioned above, the manager eIM corresponds for example to the “eSIM IoT Remote Manager”, eIM, as defined by the SGP.31 standard. Moreover, the manager eIM for managing secure elements of connected objects and the operator profile manager SM-DP+ are for example connected via an ES9+′ interface, as defined by the SGP.21 or SGP.22 standard.

The telecommunications system furthermore comprises a connected object IoT-D. This object IoT-D is connected to a communication network (not shown), such as for example the public Internet network in the context of the IoT or, for example, a GSM (acronym for “Global System for Mobile communications”), LTE (acronym for “Long-Term Evolution”) or 5G radio telecommunications network, for example, and is thereby able to communicate with other electronic systems or devices in order to obtain and/or provide information. This connected object may thus for example capture and report back, to the network, the current value of information specific to its environment and/or to its operation, and/or receive, from the network, a command the execution of which may have an effect on this environment and/or this operation.

For example, this connected object IoT-D is used in one of the following fields:
industry, then sometimes called “Industry 4.0”. In this case, the connected object IoT-D is configured for example to allow more precise monitoring of various production stages, or is integrated into a predictive maintenance system;
smart cities, for example in order to monitor and manage a traffic and transport system;
security, and the connected object IoT-D corresponds for example to a connected camera or a connected presence sensor;
health, and the connected object corresponds for example to a connected medical device or to a fall detection device used to combat loss of autonomy; and
energy, and the connected object IoT-D corresponds for example to an electricity meter communicating with an electricity grid manager.

As illustrated in FIG. 1, this connected object IoT-D comprises an eUICC-type secure element including an operating system OS. This eUICC also comprises a connected object profile assistant IPAe (acronym for “IoT Profile Assistant eUICC”), which offers functionalities enabling the eUICC of the connected object IoT-D to be provisioned by the manager SM-DP+ or via the manager eIM. This connected object profile assistant IPAe is configured in particular to allow the downloading of operator profiles within the eUICC, the transfer of operator profile management commands —such as activation, disabling or deletion of a profile—but also to allow the exchange of data (for example notifications) with the manager (eIM) for managing secure elements of connected objects and/or with the operator profile manager (SM-DP+).

As mentioned above, the connected object profile assistant conforms for example to the object profile assistant, IPA, as defined in section 4 of the SGP.31 standard. Furthermore, the manager eIM for managing secure elements of connected objects and the connected object profile assistant are for example connected via an ESipa interface, as defined by the SGP.31 or SGP.32 standard. Moreover, the operator profile manager SM-DP+ and the connected object profile assistant are for example connected via an ES9+ interface, as defined by the SGP.21 or SGP.22 standard.

The eUICC also comprises a module ISD-R (acronym for “Issuer Security Domain—Root”) generally considered to be the representative, on the eUICC, of an SM-SR (acronym for “Subscription Manager Secure Routing”) server. This module ISD-R conforms for example to the “GlobalPlatform Technology Card Specification” standard, version 2.3.1, published in March 2018.

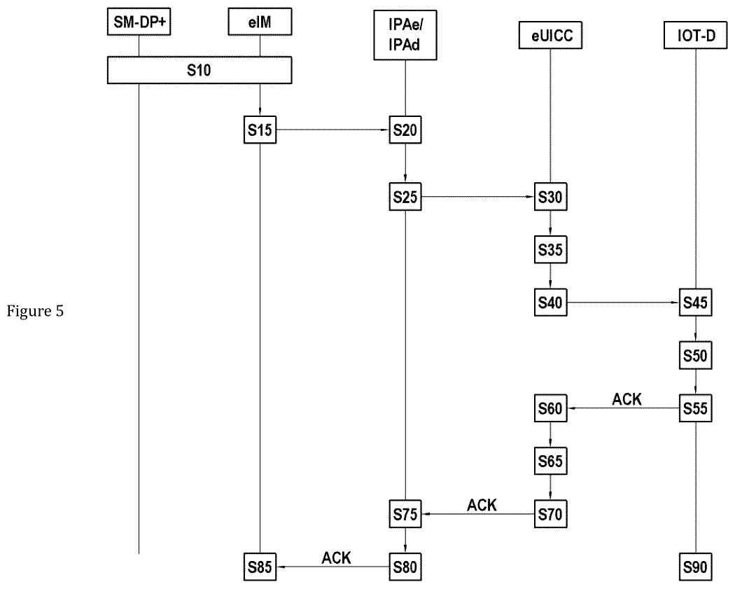

The eUICC furthermore comprises a first operator profile container ISD-P #1 (acronym for “Issuer Security Domain—Profile”) storing a first operator profile PR #1, and a second operator profile container ISD-P #2 storing a second operator profile PR #2. The operator profile containers ISD-P #1 and ISD-P #2 conform for example to the “GlobalPlatform Technology Card Specification” standard, version 2.3.1, published in March 2018. As mentioned in more detail below with reference to FIG. 5, only one of the two operator profiles is active, for example the operator profile PR #1.

It should be noted that considering two operator profiles constitutes only one implementation variant of the invention. Generally speaking, there is no limitation on the number of operator profiles able to be envisaged, for example more or fewer than two operator profiles.

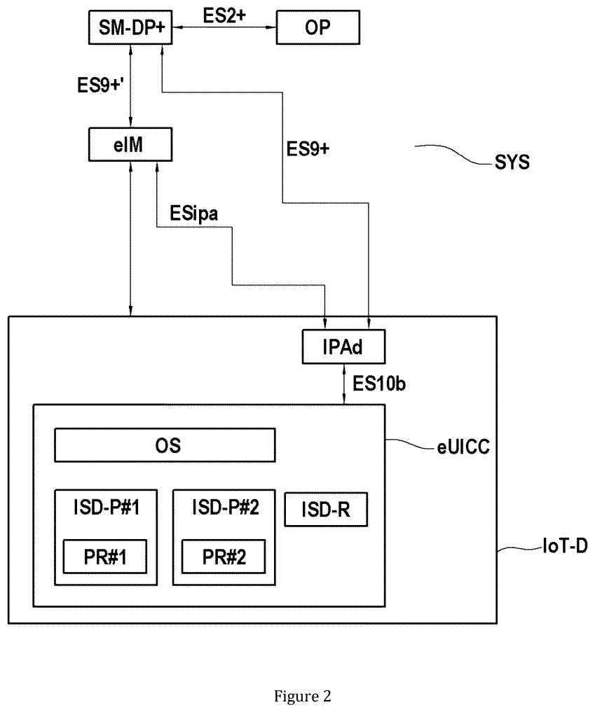

FIG. 2 is a schematic depiction of a telecommunications system, according to a second exemplary implementation.

The telecommunications system SYS is based on the configuration that has already been described above with reference to FIG. 1. Consequently, the elements mentioned in relation to FIG. 1 are adopted here, with identical reference numerals.

This telecommunications system differs from the one from FIG. 1 only in that a connected object profile assistant IPAd (acronym for “IoT Profile Assistant device”) is, this time, no longer embedded in the eUICC, but in the connected object IoT-D. In this case, the connected object profile assistant IPAd is for example connected to the eUICC via an ES10b interface, such as the one defined for example by the SGP.22, SGP.31 and/or SGP.32 standards. The assistants IPAe and IPAd therefore have similar functionalities, and only their respective location differs: the IPAe is located in the eUICC, whereas the IPAd is located outside the eUICC but in the device hosting the eUICC, that is to say the connected object IoT-D for the present invention.

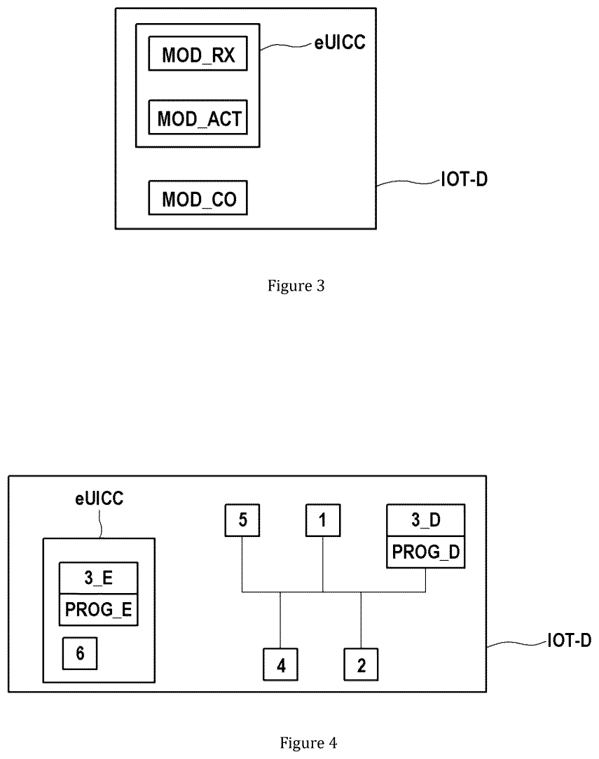

FIG. 3 shows modules embedded in a connected object, such as the connected object IoT-D belonging to the telecommunications system from FIG. 1 or 2, according to one exemplary implementation of the invention.

As illustrated in FIG. 3, the connected object IoT-D comprises in particular a secure element eUICC including:
a module MOD_RX for receiving an access point name issued beforehand by a manager eIM for managing secure elements of connected objects or by an operator profile manager SM-DP+, the access point name APN being associated with an operator of the telecommunications network;
a module MOD_ACT for activating an operator profile PR #2 associated with said operator, the operator profile PR #2 being stored within the secure element eUICC.

This connected object IoT-D also comprises a module MOD_CO for connection to the telecommunications network of the operator using the access point name APN.

FIG. 4 schematically shows one example of a hardware architecture of a connected object, such as the connected object IoT-D belonging to the telecommunications system from FIG. 1 or 2.

As illustrated by FIG. 4, the connected object IoT-D has the hardware architecture of a computer. The connected object IoT-D thus comprises in particular a processor 1, a random access memory 2, a read-only memory 3_D and a non-volatile memory 4. It also has communication means 5. The hardware elements 1, 2, 3_D, 4 and 5 are connected to one another for example by a communication bus enabling interconnection and communication between these various hardware elements.

The read-only memory 3_D of the connected object IoT-D constitutes a recording medium according to the invention, able to be read by the processor 1 and on which there is recorded a computer program PROG_D according to the invention, comprising instructions for executing steps of the connection method. The program PROG_D defines functional modules of the connected object IoT-D that rely on or control the abovementioned hardware elements 1 to 5 of the connected object IoT-D. These functional modules are shown in FIG. 3 by way of completely non-limiting illustration, and are described in more detail below with reference to various modes of implementation.

In some particular modes of implementation, the communication means 5 enable the connected object IoT-D in particular to exchange data with any equipment of the communication system SYS, including in particular the manager (eIM) for managing secure elements of connected objects and/or the operator profile manager (SM-DP+). To this end, the communication means 5 comprise a wired or non-wired communication interface capable of implementing any suitable protocol known to those skilled in the art.

As illustrated in FIG. 4, the connected object IoT-D furthermore comprises an eUICC-type secure element that also includes a read-only memory 3_E and a non-volatile memory 6. For the sake of conciseness, all of the hardware elements of an eUICC, which are also well known to those skilled in the art, have not been detailed in this text. The read-only memory 3_E of the eUICC constitutes a recording medium according to the invention on which there is recorded a computer program PROG_E according to the invention, comprising instructions for executing steps of the connection method. The program PROG_E defines functional modules of the eUICC. These functional modules are shown in FIG. 3 by way of completely non-limiting illustration, and are described in more detail below with reference to various modes of implementation.

FIG. 5 shows, in the form of a flowchart, a first particular mode of implementation of a connection method according to the invention.

As illustrated by FIG. 5, the connection method comprises a first step S10 of generating a data package. This step is implemented by the operator profile manager SM-DP+ and/or by the manager eIM for managing secure elements of connected objects. This package corresponds for example to the “eIMPackage” package as defined by the SGP.32 standard.

In the present mode of implementation, the eIMPackage package includes an “UpdateAPNList” command, referred to as “second command”, taking an access point name APN #2 and a network identifier ID_NET #2 as parameters. This second command aims to add said name APN #2 to a set of one or more access point names able to be used by the connected object IoT-D.

As mentioned above with reference to FIG. 1, the secure element eUICC comprises two operator profiles PR #1 and PR #2 recorded within a memory of this eUICC. The first profile PR #1 corresponds, in this example, to the active profile and is associated with a network ID_NET #1, and the second profile PR #2 is a disabled operator profile associated with the network ID_NET #2.

The package furthermore comprises a profile management command, referred to as “third command” and corresponding, in this example, to a command to activate the second operator profile PR #2. This third command corresponds for example to the “EnableProfile” command as defined by the SGP.22 standard.

The connection method furthermore comprises a step S15 during which the eIMPackage package is transmitted, by the manager eIM for managing secure elements of connected objects, to a connected object profile assistant IPAd, IPAe and received by this assistant in a step S20. When this connected object profile assistant is embedded within the secure element eUICC, it is then referenced IPAe, and when this connected object profile assistant is embedded within the connected object IoT-D, it is then referenced IPAd. For the sake of conciseness, the connected object profile assistants IPAe and IPAe have been grouped together in FIG. 5. Thus, the assistant IPAe is located in the eUICC and the assistant IPAd is located outside the eUICC, in the connected object IoT-D.

Next, in a step S25, this eIMPackage package is transmitted to the eUICC and received by this eUICC in a step S30. In the specific case where the connected object profile assistant IPAd is embedded within the connected object IoT-D, the package is for example transmitted via the “ES10b” interface as defined by the SGP.31 standard, and received by the module ISD-R. This receiving step S30 is for example implemented by the module MOD_RX of the eUICC.

The connection method furthermore comprises a step S35 during which the package is analysed by the eUICC, for example by the ISD-R, or, in one variant, by the operating system OS of the eUICC. This analysis step S35 includes the eUICC detecting, in the received eIMPackage package, what is referred to as a “second command”, “UpdateAPNList”, to update the set of one or more access point names able to be used with the pair (APN #2, ID_NET #2). Following this detection, the eUICC generates a command, referred to as “first command”, representative of the detection of the second “UpdateAPNList” command. Next, in a step S40, the eUICC transmits, to the connected object IoT-D, said “first command” aimed at adding said name to a set of one or more access point names able to be used by the connected object. This first command corresponds for example to the “RUN AT COMMAND” command as defined in section 6.4.23 of the ETSI TS 102 223 standard, version V14.1.1, published by ETSI in July 2018. The “RUN AT COMMAND” command thus generated is formatted so as to be able to transmit the pair (APN #2, ID_NET #2) from the eUICC to the connected object, and to allow updating of the set of one or more access point names of the connected object IoT-D.

This first command is received by the connected object IoT-D in a step S45. Next, in a step S50, in response to the receipt of this first command, the connected object updates the set of one or more usable access point names—stored for example in non-volatile memory 4. More specifically, in this step S50, the connected object IoT-D adds the pair (APN #2, ID_NET #2) to this set. Next, in a step S55, the connected object IoT-D transmits, to the eUICC, a confirmation of updating of the set of one or more names, which is received by this eUICC in a step S60. Following receipt of this confirmation of this updating, the eUICC then activates the second profile PR #2 in a step S65. This step S65 of activating a profile is for example implemented by the module MOD_ACT of the eUICC.

The connection method furthermore comprises a step S70 of transmitting, to the assistant IPAd/IPAe, a confirmation ACK of activation of the second profile PR #2. This confirmation is for example transmitted via an “eUICCPackageResult” package, which is received by the assistant in a step S75 before being retransmitted to the manager eIM for managing secure elements of connected objects in a step S80. This “eUICCPackageResult” package is then received by the manager eIM in a step S85.

Finally, the connection method comprises a step S90 during which the connected object IoT-D connects to the network ID_NET #2, using the access point name APN #2. This connection step S90 is for example implemented by the module MOD_CO of the connected object IoT-D.

The invention has been described up to now in the case where the updating of the set of one or more usable access point names takes place without errors. In the event of failure to update the set of one or more usable access point names, in step S50, the connected object IoT-D transmits, to the eUICC, a confirmation of non-updating of the set of one or more names, which is received by this eUICC in step S60. Following receipt of this confirmation of non-updating, the eUICC then does not activate the second profile PR #2 in a step S65. In this specific case, a confirmation of non-activation of the profile PR #2 is transmitted, in step S70, to the assistant IPAd/IPAe, and then to the manager eIM for managing secure elements of objects in step S80. In this specific case, the object IoT-D, in step S90, retains the previous connection state that it was in at the time when the set of one or more access point names was updated, for example “connected” to a network related to a profile PR #1 of the eUICC in the active or non-connected state.

The invention has been described up to now in the case where the “eIMPackage” package includes the “EnableProfile” command and the “UpdateAPNList” command, this “UpdateAPNList” command taking the access point name APN #2 and the network identifier ID_NET #2 as parameters.

As a variant, the “eIMPackage” package includes the “EnableProfile” command, and this “EnableProfile” command takes as a parameter a Boolean indicator, for example “UpdateList”, the value of which is representative of a request to update the set of access point names of the connected object IoT-D. In this case, the access point name APN #2 and the network identifier ID_NET #2 also correspond to parameters of the “EnableProfile” command.

The invention has also been described up to now in the case where the “eIMPackage” package includes both the “EnableProfile” command and the “UpdateAPNList” command. However, the invention is just as applicable in the case where these commands are transmitted, by the manager eIM, through two distinct “eIMPackage” packages. In this case, the package including the “UpdateAPNList” command is preferably transmitted by the manager eIM before the package including the “EnableProfile” command. Preferably, the “EnableProfile” package is transmitted by the manager eIM after it has received confirmation, by the connected object IoT-D, of the updating of the set of access point names.

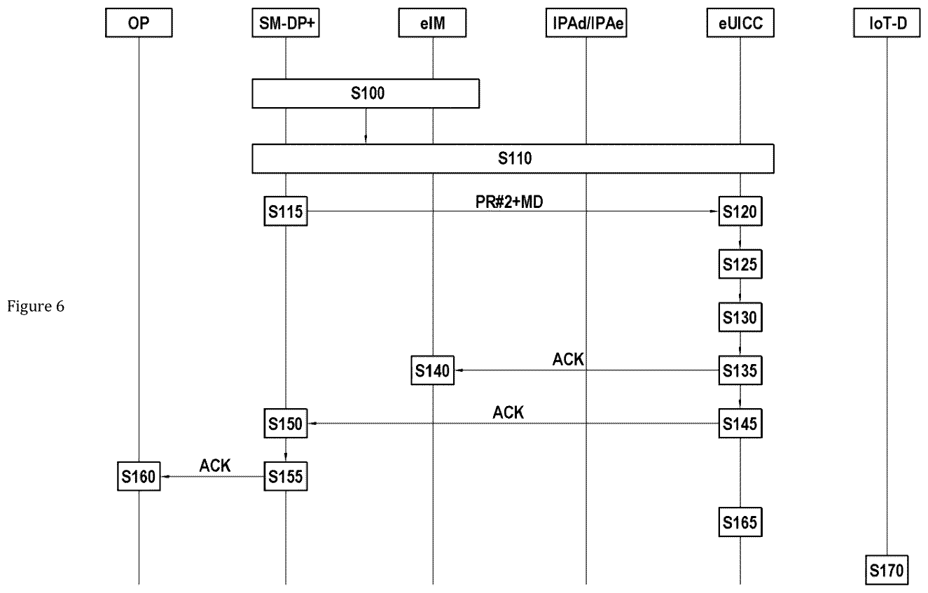

FIG. 6 shows, in the form of a flowchart, a second particular mode of implementation of a connection method.

As illustrated in FIG. 6, the connection method comprises a first step S100, implemented by the operator profile manager SM-DP+ and/or by the manager eIM for managing secure elements of connected objects, during which a secure connection is established between these two managers. As a variant, the first step S100 is implemented by the manager SM-DP+ and the eUICC via the assistant IPAd/IPAe, without the involvement of the manager eIM for managing secure elements of objects.

The connection method furthermore comprises a step S110 during which a mutual authentication procedure is implemented between the operator profile manager SM-DP+, the manager eIM for managing secure elements of connected objects, the connected object profile assistant IPAd/IPAe and the secure element eUICC. In one variant, the manager eIM for managing secure elements of connected objects is not involved in the mutual authentication procedure in step S110, and only the operator profile manager SM-DP+, the connected object profile assistant IPAd/IPAe and the secure element eUICC are involved. Next, in a step S115, the manager SM-DP+ transmits, to the secure element eUICC, an operator profile PR #2 and metadata MD associated with this profile PR #2. This profile PR #2 is an operator profile associated with the network ID_NET #2. Furthermore, these metadata include the network identifier ID_NET #2 and an access point name APN #2 for connecting to the network ID_NET #2. These data for example the profile PR #2 and the associated metadata MD-are received by the secure element eUICC in a step S120, which is for example implemented by the module MOD_RX of this eUICC.

In response to receiving these data, the eUICC records these data in the non-volatile memory 6 in a step S125, and installs the operator profile PR #2 in a step S130.

The connection method furthermore comprises a step S135 during which the eUICC transmits, to the manager eIM for managing secure elements of connected objects, a datum ACK representative of a result of the installation of the operator profile PR #2. This datum ACK is received by the manager eIM for managing secure elements of connected objects in a step S140. The datum ACK thus indicates whether the installation took place as expected and/or whether errors were generated during this installation. The secure element eUICC also transmits, in a step S145, this datum ACK to the manager SM-DP+. This datum ACK is received by the manager in a step S150, which then retransmits it to the operator OP in a step S155. The datum ACK is then received by the operator in a step S160.

The connection method also comprises a step S165 during which the secure element eUICC activates the operator profile PR #2 that it has just received. This step S165 of activating a profile is for example implemented by the module MOD_ACT of the eUICC, and is initiated following the receipt by the eUICC of a command to activate an operator profile, such as the “EnableProfile” command mentioned above. This procedure for receiving an activation command is similar to the one previously described with reference to FIG. 5, and is therefore not shown in this FIG. 6.

According to one particular implementation, the connection method furthermore comprises transmitting, to the manager eIM for managing secure elements of connected objects, a confirmation ACK of activation of this second profile PR #2 (not shown).

Finally, the connection method comprises a step S170 during which the connected object IoT-D connects to the network ID_NET #2, using the access point name APN #2. This connection step S170 is for example implemented by the module MOD_CO of the connected object IoT-D.

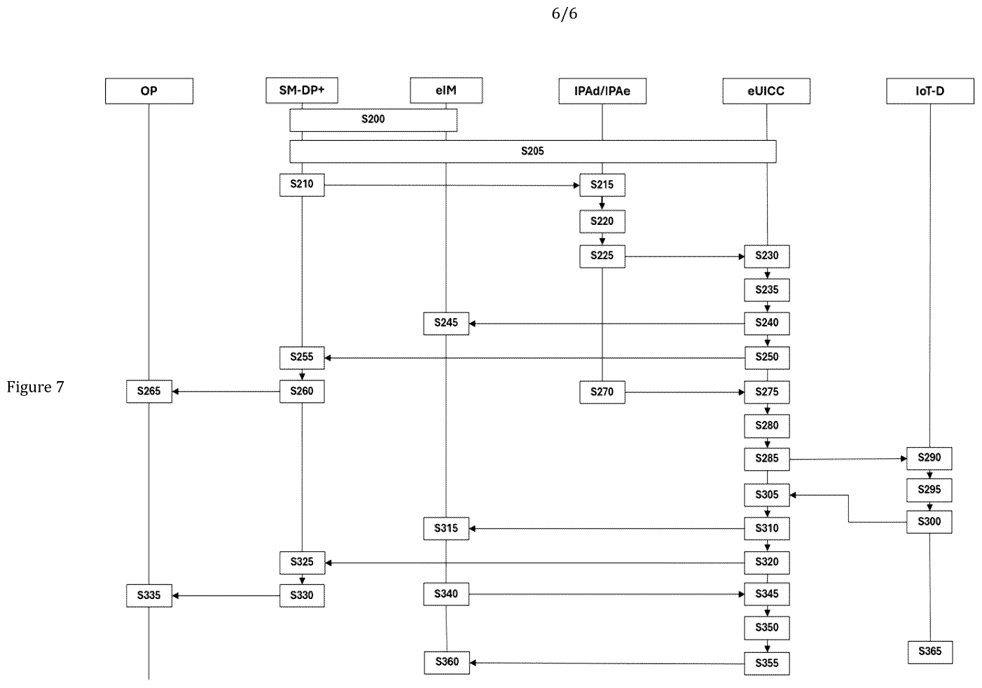

FIG. 7 shows, in the form of a flowchart, a third particular mode of implementation of a connection method.

As illustrated in FIG. 7, the connection method comprises a first step S200, implemented by the operator profile manager SM-DP+ and/or by the manager eIM for managing secure elements of connected objects, during which a secure connection is established between these two managers. As a variant, the first step S200 is implemented by the manager SM-DP+ and the eUICC via the assistant IPAd/IPAe, without the involvement of the manager eIM for managing secure elements of objects.

The connection method furthermore comprises a step S205 during which a mutual authentication procedure is implemented between the operator profile manager SM-DP+, the manager eIM for managing secure elements of connected objects, the connected object profile assistant IPAd/iPAe IPAe and the secure element eUICC. In one variant, the manager eIM for managing secure elements of connected objects is not involved in the mutual authentication procedure in step S205, and only the operator profile manager SM-DP+, the connected object profile assistant IPAd/IPAe and the secure element eUICC are involved.

The connection method furthermore comprises a step S210 during which an operator profile PR #2 and metadata MD associated with this profile PR #2 are transmitted, as part of a profile loading and installation procedure, by the manager SM-DP+ to a connected object profile assistant IPAd, IPAe, and received by this assistant in a step S215. The profile PR #2 is an operator profile associated with the network ID_NET #2. Furthermore, the metadata of the profile PR #2 include a network identifier ID_NET #2 and an access point name APN #2 for connecting to the network ID_NET #2. As mentioned previously, when the connected object profile assistant is embedded within the secure element eUICC, it is then referenced IPAe, and when this connected object profile assistant is embedded within the connected object IoT-D, it is then referenced IPAd.

In a step S220, the assistant IPAd/IPAe analyses the metadata MD of the operator profile PR #2 and detects the APN configuration parameters ID_NET #2 and APN #2. This detection may take place while the assistant IPAd/IPAe is receiving the profile PR #2, or when the assistant IPAd/IPAe has received the entire profile PR #2 and the profile PR #2 has finished loading.

In a step S225, the assistant IPAd/IPAe transmits the profile PR #2 and the metadata MD to the eUICC, which are received by this eUICC in step S230. In the specific case where the connected object profile assistant IPA is embedded within the connected object IoT-D (assistant IPAd), the profile PR #2 and the metadata are for example transmitted via the “ES10b” interface as defined by the SGP.31 standard, and received by the module ISD-R. This receiving step S230 is for example implemented by the module MOD_RX of the eUICC.

Following receipt of the profile PR #2 and the associated metadata in step S230, the eUICC installs the profile PR #2 in a step S235.

The connection method furthermore comprises a step S240 during which the eUICC transmits, to the manager eIM for managing secure elements of connected objects, a datum “ACK_INSTPRO” representative of a result of the installation of the operator profile PR #2. This datum “ACK_INSTPRO” is received by the manager eIM for managing secure elements of connected objects in a step S245. The datum ACK_INSTPRO thus indicates whether the installation of the profile took place as expected and/or whether errors were generated during this installation. The secure element eUICC also transmits, in a step S250, this datum ACK_INSTPRO to the manager SM-DP+. This datum ACK_INSTPRO is received by the manager SM-DP+ in a step S255, which then retransmits it to the operator OP in a step S260. The datum ACK_INSTPRO is then received by the operator in a step S265.

The connection method furthermore comprises a step S270 of the assistant IPAd/IPAe transmitting, to the eUICC, a command referred to as “second command” or “UpdateAPNList”, which is received (and detected) by the eUICC in a step S275, for example by its module ISD-R. In the specific case where the connected object profile assistant IPA is embedded within the connected object IoT-D (assistant IPAd), this second command is for example transmitted to the eUICC via the “ES10b” interface as defined by the SGP.31 standard, and received by the module ISD-R. This “UpdateAPNList” command is formatted so as to contain at least the data pair (APN #2, ID_NET #2).

Following receipt and detection S275 of the second command, the eUICC generates, in a step S280, a command, referred to as “first command”, representative of the detection of the second “UpdateAPNList” command to update the set of one or more access point names able to be used with the pair (APN #2, ID_NET #2) when it is received in step 275.

Next, in a step S285, the eUICC transmits, to the connected object IoT-D, this “first command” aimed at adding said name to a set of one or more access point names able to be used by the connected object. This first command corresponds for example to the “RUN AT COMMAND” command as defined in section 6.4.23 of the ETSI TS 102 223 standard, version V14.1.1, published by ETSI in July 2018. The “RUN AT COMMAND” command thus generated is formatted so as to be able to transmit the pair (APN #2, ID_NET #2) from the eUICC to the connected object, and to allow updating of the set of one or more access point names of the connected object IoT-D.

This first command is received by the connected object IoT-D in a step S290. Next, in a step S295, in response to the receipt of this first command, the connected object IoT-D updates the set of one or more usable access point names—stored for example in non-volatile memory 4. More specifically, in this step S295, the connected object IoT-D adds the pair (APN #2, ID_NET #2) to this set.

Next, in a step S300, the connected object IoT-D transmits, to the eUICC, a datum “ACK_APNUPD” representative of a result of the updating of the set of one or more names, which is received by this eUICC in a step S305. The datum ACK_APNUPD thus indicates whether the installation took place as expected and/or whether errors were generated during this installation.

The connection method furthermore comprises a step S310 during which the eUICC transmits, to the manager eIM for managing secure elements of connected objects, the datum “ACK_APNUPD”. This datum “ACK_APNUPD” is received by the manager eIM for managing secure elements of connected objects in a step S315. The secure element eUICC also transmits, in a step S320, this datum “ACK_APNUPD” to the manager SM-DP+. This datum “ACK_APNUPD” is received by the manager SM-DP+ in a step S325, which then retransmits it to the operator OP in a step S330. The datum ACK is then received by the operator in a step S335.

The connection method also comprises a step S350 during which the secure element eUICC activates the operator profile PR #2. This step S350 of activating a profile is for example implemented by the module MOD_ACT of the eUICC, and is initiated following the receipt S345 by the eUICC of a command to activate an operator profile, such as the “EnableProfile” command. This “EnableProfile” command is for example defined in the GSMA SGP.32 standard and transmitted, by the manager eIM for managing secure elements of connected objects, to the eUICC via the assistant IPAd/IPAe during a step S340.

According to one particular implementation, the connection method furthermore comprises the eUICC transmitting S355, to the manager eIM for managing secure elements of connected objects, a confirmation ACK_ACT of activation of this second profile PR #2. This confirmation ACK_ACT is received by this manager eIM in a step S360.

Finally, the connection method comprises a step S365 during which the connected object IoT-D connects to the network ID_NET #2, using the access point name APN #2. This connection step S365 is for example implemented by the module MOD_CO of the connected object IoT-D.

1. A method for connecting a connected object embedding a secure element to a telecommunications network, the method comprising:
the secure element receiving an access point name issued beforehand by a manager for managing secure elements of connected objects or by an operator profile manager the access point name being associated with an operator of the telecommunications network;
the secure element activating an operator profile associated with said operator, the operator profile being stored within the secure element; and
the connected object connecting to the telecommunications network of the operator using said access point name.

2. The method according to claim 1, further comprising, prior to activation,
the connected object receiving from the secure element, said access point name and a first command, aimed at adding said name to a set of one or more access point names able to be used by the connected object; and
the connected object adding said access point name to said set of one or more access point names.

3. The method according to claim 1, further comprising the manager for managing secure elements of connected objects transmitting said access point name to the secure element via a connected object profile assistant.

4. The method according to claim 3, wherein the connected object profile assistant is embedded within the secure element or the connected object.

5. The method according to claim 3,
wherein the method further comprises, prior to activation, the connected object receiving, from the secure element, said access point name and a first command, aimed at adding said name to a set of one or more access point names able to be used by the connected object, and the connected object adding said access point name to said set of one or more access point names, and
wherein said access point name is transmitted by the manager for managing secure elements of connected objects to the secure element with a second command, able to be interpreted by said secure element and aimed at transmitting said first command to the connected object.

6. The method according to claim 3,
wherein the method further comprises, prior to activation, the connected object receiving, from the secure element, said access point name and a first command, aimed at adding said name to a set of one or more access point names able to be used by the connected object, and the connected object adding said access point name to said set of one or more access point names, and
wherein said access point name is transmitted by the manager for managing secure elements of connected objects to the secure element with a third command, to activate an operator profile of the secure element, said third command comprising a parameter representative of a request to update the set of one or more access point names of the connected object.

7. The method according to claim 3, wherein the access point name and, where applicable, a second command or a third command are transmitted in a data package.

8. The method according to claim 1, wherein the access point name is transmitted by the operator profile manager as part of loading an operator profile onto the secure element of the connected object, and the receiving further includes receiving said operator profile.

9. The method according to claim 8, further comprising the secure element processing said access point name as a metadatum associated with said operator profile.

10. A non-transitory computer readable medium having stored thereon a program including instructions for implementing the method according to claim 1.

11. (canceled)

12. A connected object embedding a secure element comprising:
circuitry configured to:
receive, within the secure element, an access point name issued beforehand by a manager for managing secure elements of connected objects or by an operator profile manager, the access point name being associated with an operator of a telecommunications network,
activate, within the secure element, an operator profile associated with said operator, the operator profile being stored within the secure element; and
connect to the telecommunications network of the operator using said access point name.

13. A telecommunications system comprising a manager for managing secure elements of connected objects and the connected object according to claim 12.

14. A telecommunications system comprising an operator profile manager and the connected object according to claim 12.

15. The method according to claim 2, further comprising the manager for managing secure elements of connected objects transmitting said access point name to the secure element via a connected object profile assistant.

16. The method according to claim 4,
wherein the method further comprises, prior to activation, the connected object receiving, from the secure element, said access point name and a first command, aimed at adding said name to a set of one or more access point names able to be used by the connected object, and the connected object adding said access point name to said set of one or more access point names, and
wherein said access point name is transmitted by the manager for managing secure elements of connected objects to the secure element with a second command, able to be interpreted by said secure element and aimed at transmitting said first command to the connected object.

17. The method according to claim 4,
wherein the method further comprises, prior to activation, the connected object receiving, from the secure element, said access point name and a first command, aimed at adding said name to a set of one or more access point names able to be used by the connected object, and the connected object adding said access point name to said set of one or more access point names, and
wherein said access point name is transmitted by the manager for managing secure elements of connected objects to the secure element with a third command, to activate an operator profile of the secure element, said third command comprising a parameter representative of a request to update the set of one or more access point names of the connected object.

18. The method according to claim 17, wherein the access point name and, where applicable, a second command or the third command are transmitted in a data package.

19. The method according to claim 4, wherein the access point name and, where applicable, a second command or a third command are transmitted in a data package.

20. The method according to claim 5, wherein the access point name and, where applicable, the second command or a third command are transmitted in a data package.

21. The method according to claim 6, wherein the access point name and, where applicable, a second command or the third command are transmitted in a data package.
